(19) United States
(12) Patent Application Publication
(10) Pub. No.: US 2015/0121717 A1
(43) Pub. Date: May 7, 2015

(54) METHOD AND MACHINE FOR DRYING MATERIALS

(71) Applicant: DEANTEC GMBH, Kirchhundem (DE)

(72) Inventor: Falk Denke, Kirchhundem (DE)

(21) Appl. No.: 14/407,344

(22) PCT Filed: May 16, 2013
(86) PCT No.: PCT/EP2013/060204

§ 371 Date: Dec. 11, 2014

(30) Foreign Application Priority Data
Jun. 11, 2012 (DE) 102012011384.6

(51) Int. Cl. F26B 21/08

(52) U.S. Cl. CPC F26B 21/086
USPC 34/468; 34/73

(57) ABSTRACT

A method and a drying machine for drying materials, for example foundry sands, laundry, chemical pulps and/or bulk materials. The materials to be dried are loaded into a drying container, in which liquid is vaporized. The steam produced is passed into a condensation chamber and condensed there in thermal contact with the material from the drying container. In this way, the heat of condensation can be recovered for a renewed vaporizing process. The drying machine may be used in particular in a regeneration plant for inorganically bound foundry sands.

The invention relates to a drying machine and to a method for the drying of materials, for example of foundry sands, laundry, cellulose materials and/or bulk materials. It relates, furthermore, to a machine and to a method for the washing or regeneration of materials.

In known laundry dryers, the laundry to be dried is located in a horizontally rotating drum. It is thereby circulated continuously, and a large effective surface of the laundry is achieved. Heated air flows along the drum axis of rotation through the wet laundry in the direction of the door. The dry hot air is in this case capable of absorbing the moisture of the laundry up to the saturation limit. After the moist air has passed through a lint screen, it is typically blown into the open.

Against this background, the object of the present invention was to provide means for the cost-effective drying of materials.

This object is achieved by means of a drying machine as claimed in claim 1, by means of a method as claimed in claims 2 and 9, by means of a washing plant as claimed in claim 7 and by means of a regeneration plant as claimed in claim 8. Advantageous refinements are contained in the subclaims.

According to a first aspect, the invention relates to a drying machine for the drying of materials, such as, for example, foundry sands, laundry, cellulose materials and/or bulk materials. The term “materials” is therefore intended to embrace both pure materials and material mixtures. The foundry sands may in general be, in particular, inorganically bound foundry sands. The drying machine contains the following components:
A drying container for receiving the materials to be dried.
A condensation chamber which is connected to the drying container and in which steam can be condensed out of the drying container in thermal contact with material located in the drying container.

The steam mentioned is typically that which has been generated by the evaporation of liquid out of the material in the drying container. Moreover, the term “steam” is to be understood in general to mean a homogeneous (gaseous) or heterogeneous (droplet-like) distribution of liquid particles in a carrier gas (for example, air). A typical example is water vapor which has occurred as a result of the evaporation of water out of the materials to be dried.

According to a second aspect, the invention relates to a method for the drying of materials, such as, for example, foundry sands, laundry, cellulose materials and/or bulk materials, which contains the following steps:
Evaporation of liquid out of the materials to be dried.
Condensation of the evaporated liquid (that is to say, of the steam generated in the first step) in thermal contact with the material out of which the liquid has been evaporated.

The method can be carried out, in particular, in a drying machine of the type described above. Explanations and definitions of the drying machine are therefore also applicable analogously to the method, and vice versa.

The drying machine and the method have the advantage that the energy used for the evaporation of liquid is recovered as a result of the condensation of the steam occurring and, due to the thermal contact with the material to be dried, can be utilized for further evaporation processes. An especially efficient, energy-saving and cost-effective drying of materials can thereby be achieved.

Various developments which can be applied both to the drying machine and to the method are described below.

In principle, the drying container and the condensation chamber could be completely or partially overlapping or identical, that is to say drying and condensation can take place in the same container/space. Preferably, however, the drying container in which the evaporation of liquid out of the materials to be dried takes place is separated structurally from the condensation chamber. The situation can thereby be prevented where condensed steam is precipitated again in the materials to be dried and the drying result is thus nullified.

It is especially preferable if the drying container and the condensation chamber are separated by a common wall, since the condensation heat occurring in the condensation chamber can then pass (back) into the drying container over a short distance as a result of heat conduction. In particular, the wall mentioned can be designed with high heat conductivity, for example in that it is composed of metal.

The condensation chamber may advantageously (completely or partially) surround the drying container. For example, the drying container may be cylindrical and the condensation chamber surround the cylinder along the lateral surface area of the latter. Alternatively, a reverse arrangement may also be envisaged, in which the drying container surrounds the condensation chamber, so that all the heat occurring in the condensation chamber necessarily has to travel through the drying container before it can pass into the surroundings.

The drying container may, in particular, contain a rotatably mounted drum dryer (also called a “drying drum”) or be composed thereof. As a result of the rotatability of such a drum, a constant intermixing of the materials to be dried can be achieved, thus giving rise to an efficient extraction of liquid.

In the above embodiment, the condensation chamber may optionally be likewise rotatable, preferably in that it is connected firmly to the drum dryer. However, it is also possible to design the condensation chamber so as to be stationary or so as to be movable independently of the drum dryer. For example, the drum dryer may be mounted rotatably in a stationary condensation chamber.

The drying container and/or the condensation chamber are/is preferably configured such that they can be closed in a pressure-tight manner. For example, the drying container may have a door or flap which can be locked in a pressure-tight manner. Inside the drying container or condensation chamber, pressures independent of the ambient pressure can then be set in order to assist the processes taking place.

Thus, for example, it is advantageous if the pressure in the condensation chamber is set higher than the pressure in the drying container. The evaporated liquid then condenses in the condensation chamber at a higher temperature than that at which it evaporates in the drying container. A heat flow from the condensation chamber to the drying container can thus be generated. In an advantageous embodiment of the invention, a compressor for increasing the pressure in the condensation chamber and/or for reducing the pressure in the drying container may be present. Consequently, for example, the above-described pressure drop between the condensation chamber and drying container can be generated. The compressor may be arranged in a stationary manner. If the drying machine contains rotatable parts, such as, for example, a drum dryer, the compressor may also be connected to these, that is to say may itself be rotatable. Moreover, parts of the compression system, such as, for example, a pump, may be mounted in a stationary manner and be connected to moveable parts of the drying machine via rotary connections.

According to a further aspect, the invention relates to a washing plant, in particular, to a washing plant for materials, such as, for example, foundry sands, laundry, cellulose materials and/or bulk materials, which contains the following components:
A washing chamber in which the materials to be cleaned can be mixed with a washing liquid.
A drying machine of the type described above, in which residues of the washing liquid can be evaporated out of the washing chamber from materials. That is to say, the materials mixed with washing liquid in the washing chamber are brought, (if they are not already there) into the drying container of the drying machine, where the washing liquid is evaporated and transferred into the condensation chamber, in which it condenses out of the drying container in thermal contact with the material.

For carrying out the washing operation, the washing chamber is typically provided with supply and/or discharge lines for washing liquid (for example, water).

The washing chamber of the washing plant may be a component separate from the drying machine. However, it may also be integrated into the drying machine, for example in that the washing chamber and drying container overlap or are (completely or partially) identical. A washing operation can then first take place in the drying container (that is to say, it serves as a washing chamber), followed by the drying of the washed materials.

The washing chamber may optionally have a rotatably mounted part, the inner space of which is connected (in a fluid-conducting manner) to the inner space of a stationary part. For example, the washing chamber may contain a rotatable drum which is connected via at least one hole to an outside space in a stationary housing. Then, for example, the supply and discharge of washing liquid can take place via the outside space. In this embodiment, the condensation chamber may, for example, be formed together with the inner part/with the drum, or it may be stationary together with the outer part.

According to a further aspect, the invention relates to a regeneration plant for materials, such as, for example, inorganically bound foundry sands, which, in particular, may be configured in the way described above and which contains the following components:
A washing drum in which the material mixture can be mixed with a washing liquid, preferably with water. As a result of this mixing, specific constituents of the material mixture come loose, so that they can be separated, together with the washing liquid, from the rest (=washed material).
A drum dryer, of which the inlet for material to be dried is connected to the outlet of the washing drum, so that said drum dryer can be filled with the material washed in the washing drum. Furthermore, in the drum dryer, the parts of the washing liquid which still adhere to the material introduced are evaporated.

The washing drum constitutes a special form of a washing chamber of the type described above, while the drum dryer is a special form of a drying container.

The invention relates, furthermore, to a method for the regeneration of material mixtures, such as, for example, inorganically bound foundry sands, which can be carried out, in particular, by means of the abovementioned regeneration plant. The method comprises the steps:
Mixing of the material mixture with a washing liquid, such as, for example, water, mixing preferably taking place in a washing drum.
Discharge of washing liquid (from the washing drum), together with constituents of the material mixture which are dissolved therein.
Evaporation of residues of the washing liquid, evaporation preferably taking place in a drum dryer.

Developments of the washing plant, of the regeneration plant and of the method, which can in each case be implemented alone or in combinations with one another, are described below.

Thus, the washing drum or washing chamber is preferably rotated jointly with the drum dryer or with the drying container. Only one drive (motor) is therefore required. The rotational speed of the two drums may be identical or different, and in the last-mentioned case, for example, a gear may be used for coupling the drums. The drums may otherwise be connected firmly.

Evaporated washing liquid is advantageously condensed while it is in thermal contact with the material out of which washing liquid is evaporated. The condensate and said material are in this case usually separated substantively from one another, so that renewed intermixing does not take place. As a result of thermal contact, however, the condensation energy can flow back into said material (heat recovery). Condensation may take place, in particular, on the outer casing of the drum dryer.

The pressure of the evaporated washing liquid is preferably increased before or during its condensation. In particular, said pressure can be increased to a value which is higher than the pressure in the drum dryer. What can be achieved thereby is that the temperature of the condensate is higher than the evaporation temperature, with the result that the transport of heat in the desired direction occurs.

In all the machines, plants and methods described above, the materials to be dried or to be cleaned can be fed and processed in batches. Additionally or alternatively, however, it is also possible to feed and process the materials continuously.

The invention is explained in more detail below, by way of example, with the aid of the figures in which:

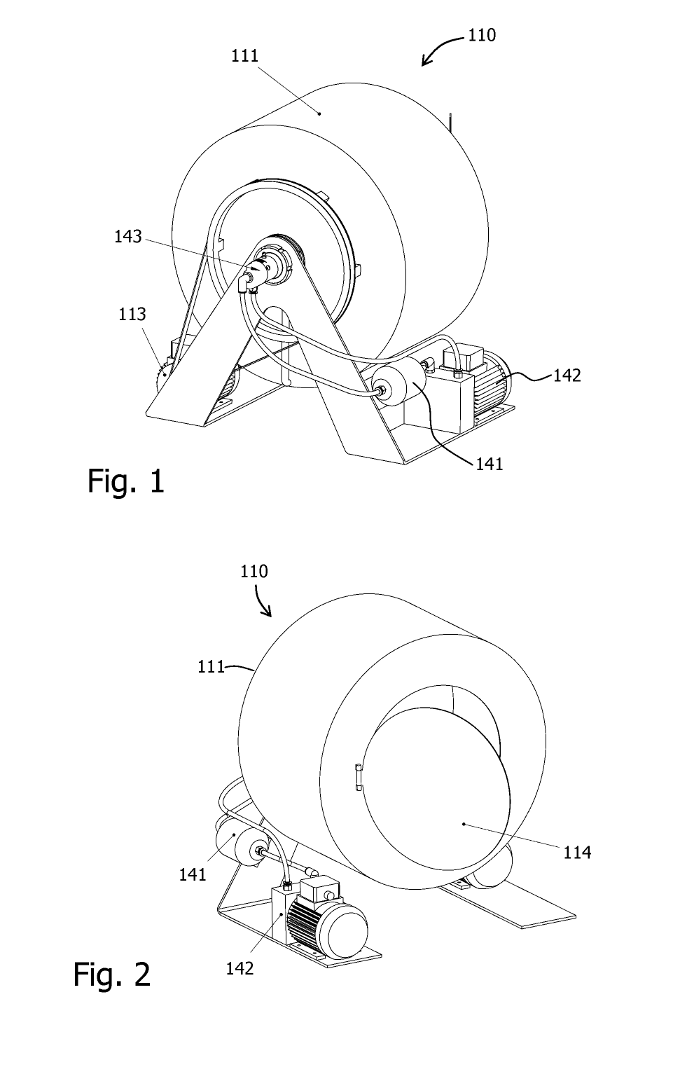

FIG. 1 shows the rear side of a drying machine according to a first embodiment of the invention;

FIG. 2 shows the front side of the drying machine of FIG. 1;

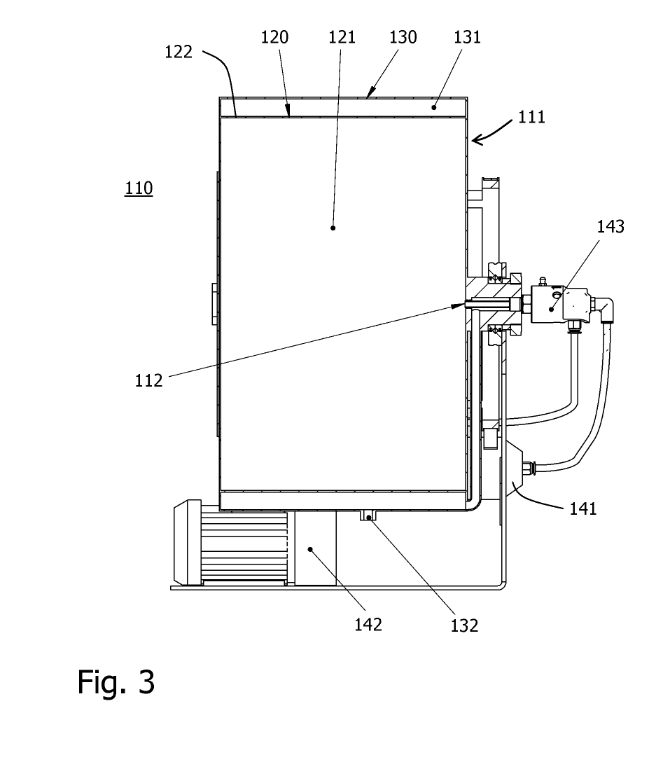

FIG. 3 shows a vertical section through the drying machine of FIG. 1;

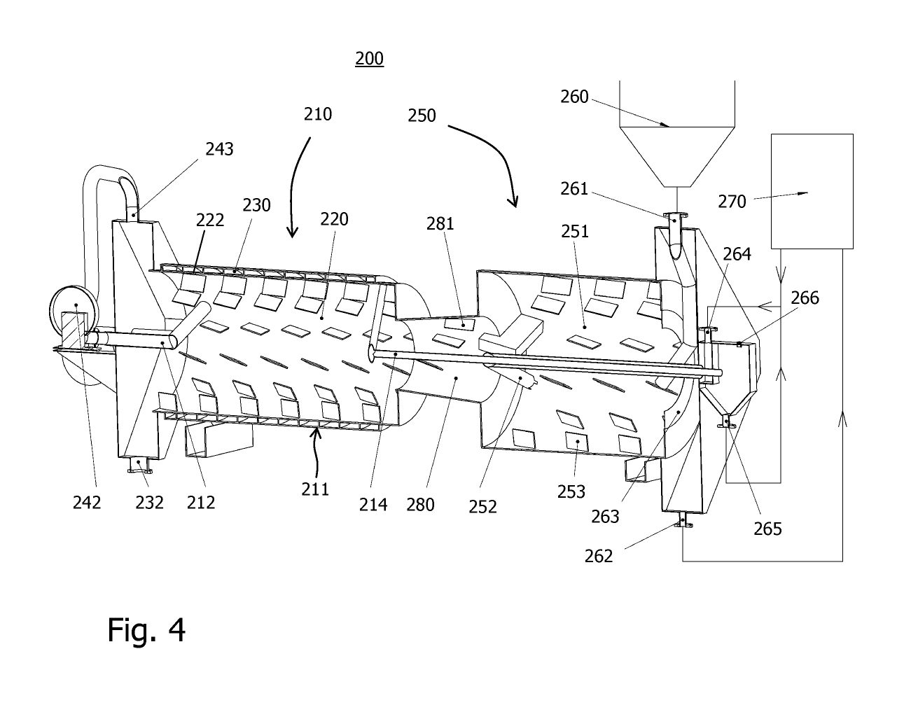

FIG. 4 shows a vertical section through a regeneration plant according to another embodiment of the invention;

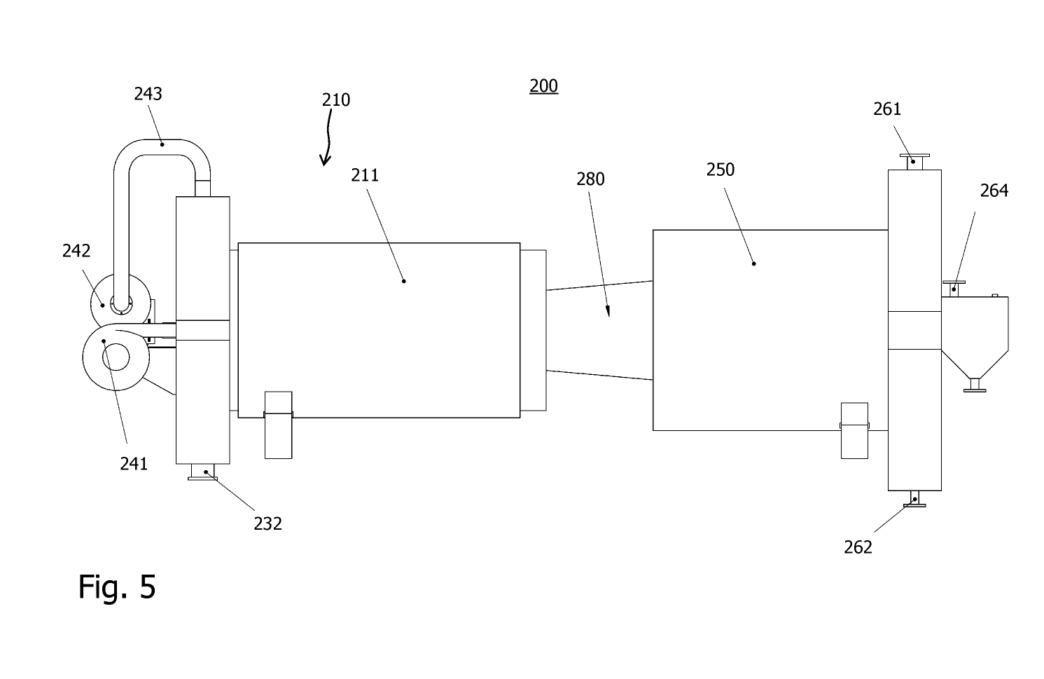

FIG. 5 shows a side view of the regeneration plant of FIG. 4;

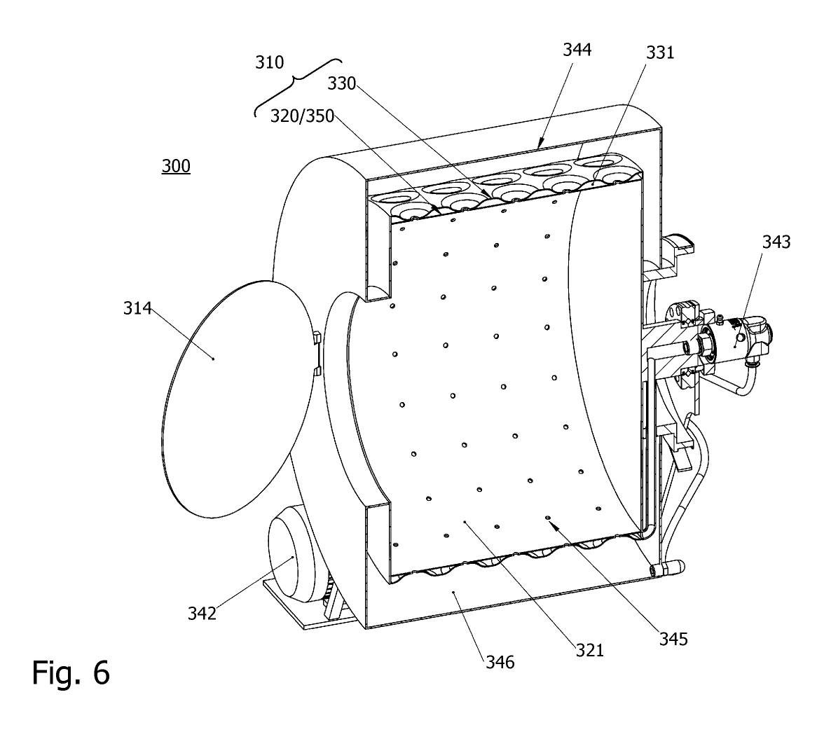

FIG. 6 shows a modification, designed as a washing dryer, of the drying machine of FIGS. 1-3.

Similar or identical structural parts, as a rule, bear in the figures reference symbols which differ from one another by multiples of 100.

Known methods for the drying of materials require a high energy outlay on account of the high evaporation energy during the phase transition of water from the liquid to the gaseous phase. This disadvantage is avoided by means of the drying machine 110, shown in FIGS. 1-3, according to a first embodiment of the invention.

The drying machine 110 contains a drum 111 with an outer casing and an inner casing 122 which between them enclose an interspace 131 and thus form a “condensation chamber” 130.

The stock to be dried (for example, laundry, cellulose materials and/or bulk materials) can be introduced into the inner space 121 of the “drying container” 120 formed by the inner casing 122. The drum 111 can then be closed by closing a flap 114. Said drum, driven by a motor 113, can preferably rotate about the drum axis.

During operation, the temperature and pressure are selected in the inner space 121 of the drying container 120 such that a two-phase zone of water and water vapor is obtained. Depending on the desired drying temperature, this can take place by underpressure or overpressure or in a pressureless manner (atmospheric pressure).

In the example illustrated, a compressor 142 is mounted at a fixed location and is connected on the inlet side to the interior of the drying container 120 and on the outlet side to the condensation chamber 130.

The energy required for this operation is supplied in the form of heat preferably via the surface 122 of the inner drum 120. For this purpose, steam is sucked out of the drying container 120 through an outlet 112 of the inner drum, is compressed to a higher pressure by means of the compressor 142 and is conducted into the condensation chamber 130 between the inner and the outer drum. In its inner space 131 (between the outer and the inner drum), due to the higher pressure the steam then condenses at a higher temperature than the temperature in the drying container 120. This results in a heat flow through the inner drum wall 122 to the stock to be dried. The evaporation energy is thereby recovered effectively by condensation.

The (entire) drum 111 should preferably be thermally insulated outwardly in order to reduce heat losses.

The heat energy for heating the system to operating temperature, the energy for the compensation of losses and the energy for operation can be fed in preferably by heating the steam by means of a steam heater 141 or directly via the inner and/or outer drum casing. The amount of heat required for the drying operation is reduced by the amount which is released as a result of the condensation of the steam.

The condensate occurring can be pumped out or drained from the condensation chamber 130 on the outside of the latter via a condensate drain 132. The discharge of the condensate may take place during continuous operation or, if the interspace 131 between the outer and the inner drum has sufficiently large dimensioning, cyclically or at the end of the drying operation when the drum is stationary.

In a modification of the drying machine 110 described, the outer drum which forms the condensation chamber 130 is designed as a static housing into which the steam is introduced in order to condense there preferably at higher pressure. The inner drum 120 then rotates in the static housing. In this case, the rotary connector to the condensation chamber may be dispensed with.

In summary, it can be stated that the drying machine 110 described and the method which can be carried out with it have optionally one or more of the following structural parts or features:
A drying container 120 which is designed as a drum dryer and the inlet of which can be closed, preferably pressure-tight, by means of a door or cover 114, with an orifice 112 for sucking away water vapor.
An outer drum casing with an interspace 131 relative to the inner drum casing 122 and/or with ducts or pockets, attached to the (inner) drum casing, for the passage or introduction of steam and/or condensate.
The introduction of the stock to be dried into the drying container 120.
The evaporation of the water out of the materials.
A compressor 142 is located next to the drum 111 and is connected to the drum via rotary leadthroughs 143.
A compressor corotates with the drum, with the result that rotary leadthroughs may be dispensed with.
Drying takes place in batches.
Drying takes place continuously.
Evaporated liquid is condensed in thermal contact with the material out of which the liquid is evaporated.
The pressure of the evaporated liquid is increased before or during its condensation.
The dryer is combined with a washing drum in which the washing operation takes place before the drying operation.
The drum is located in a stationary or moving housing, and the drum interior is connected to the housing by means of ducts, holes or a perforation, thereby forming as a whole the evaporation or drying space (cf. FIG. 6).
The condensation space is located on an outer housing for transmitting the heat to the evaporation space.

FIGS. 4 and 5 illustrate an apparatus for the regeneration of inorganically bound foundry sands according to another embodiment of the invention.

In the regeneration of chemically bound silica sands, it is important, after the comminution of silica sand lumps, to clean off the binding residues from the grains, so that the sand can subsequently be reused for the production of casting molds.

Chemically bound foundry sands are primarily cleaned mechanically or thermally. Whereas, in mechanical regeneration, the binding residues are removed by friction or impact, in thermal regeneration the binding residues are burnt. However, burning is possible only in the case of binders based on organic compounds. Where inorganic binders are concerned, there are no constituents which could be released from the grain by burning.

In mechanical regeneration, the released binding residues are blown out of the bulk material by screening. In mechanical regeneration, there is usually always grain destruction. By being rubbed against one another or by impact, silica grains may break up or parts of them break out. This gives rise to dust, and the grain fraction becomes increasingly finer. Ever coarser sand therefore has to be admixed.

Thermal regeneration entails a high energy outlay because the silica sand has to be heated to above the flashpoint of the binders. This often makes the method uneconomic.

Drum dryers are used for the drying of bulk materials. In this case, the bulk material is introduced on one side into a horizontally or obliquely arranged rotating drum. By means of blades inside the drum and as a result of rotation, the material is conveyed upward by rotation and then falls down again through the center of the drum.

In the center of the drum the bulk material is heated by means of a gas burner or by another kind of introduction of heat and is thus dried by the water being evaporated. Due to the geometry of the blades and/or to the oblique position of the drum, the material is conveyed from the feed point of the drum to its end. Owing to the high evaporation enthalpy in the phase transition of the water from the liquid to the gaseous phase, this type of drying requires a high energy outlay.

The problems addressed above are solved by means of the regeneration plant 200, illustrated in FIGS. 4 and 5, for inorganically bound foundry sands.

Inorganically bound sands, as a rule, are water-soluble, and therefore the binders can simply be washed away with water or by the addition of cleaning agents. In the exemplary embodiment illustrated, the “Deantec” regeneration plant 200 comprises a drum composed of a washing drum 250, of a draining drum 280 or centrifuge and of a drying drum 210, 220 (also called a “drum dryer”). In the case that one draining drum is sufficient, all three drums can rotate together at the same rotational speed.

The broken foundry sand is directly introduced continuously from a silo 260 or by means of a suitable conveying device into the bulk material inflow 261 which leads into the interior 251 of the washing drum 250.

The cleaning liquid is introduced continuously into the cleaning liquid inflow 264. By means of line ducts 252, the washing liquid is conducted in the region of the sand outflow of the washing drum 250 into the interior 251 of the drum.

In the washing drum 250, the sand runs through the drum 250 as a result of the rotation of the drum 250 and the arrangement of guide blades 253. The bulk material is in this case lifted by the guide blades 253. Beyond a certain angle of rotation, the bulk-material/cleaning-agent mixture runs off the guide blades 253 and, depending on the rotational speed of the drum 250, falls down again through the drum center. Owing to the oblique arrangement of the guide blades 253, the sand always falls somewhat further in the direction of the washing drum outflow (sand outflow), thus giving rise to a conveying direction. The conveying direction could likewise be achieved by the drum 250 being positioned slightly obliquely.

The washing liquid runs, in the region of the sand inflow 261, through a screen 263 and out of the washing drum again through the washing liquid outflow 262. The washing liquid, together with the binder residues dissolved in the washing liquid, is then pumped into the washing liquid treatment plant 270.

The sand/washing-liquid mixture is drained in the outlet region 280 of the washing drum 250. Owing to the conicity of this region, the water runs in the direction of the washing drum 250 as a result of gravity. The sand is conveyed in the direction of the drum dryer 210, 220 by guide blades 281.

Alternatively, a centrifuge could also be installed at this location in order to throw out the washing liquid. The sand, including the residual moisture present, then runs into a drying machine 210, the “drum dryer”, with the recovery of condensation energy.

In the drum dryer 210 or in its drying container (inner drum 220), the sand is heated by means of a gas burner 241 or other devices for the introduction of heat, until the boiling temperature of the washing liquid is reached. The water vapor occurring flows via the steam line 243 out of the drum 220 and is brought by means of a compressor 242 to a higher pressure which is preferably higher than the pressure of the water vapor inside the drum 220. The water vapor is then conducted through the steam line 212 in an outer drum section 230, the “condensation chamber”, around the inner drum 220.

The steam then condenses in the outer drum section 230 and transmits the condensation energy to the inner drum section 220. The heat energy in this case released corresponds to the energy which was absorbed during the evaporation of the water.

As a result of the preferred pressure difference between the drum interior (220) and drum exterior (230), the evaporation temperature is lower than the condensation temperature. This gives rise to a heat flow from the condensate through the inner drum wall 222 towards the bulk material. The introduction of external heat energy can thereby be reduced by the amount of heat which is introduced via the drum wall.

The condensed washing liquid is led through the washing water outflow 265 out of the washing drum 250 through a line 214 which runs centrally through the washing drum and can then be pumped directly into the washing water inflow 264.

Gases which are introduced into the drum via the sand can be discharged from the system via a pressure limiting valve through an orifice 266 at the inlet of the washing drum 250.

By virtue of the arrangement of the guide blades or an oblique position of the drying drum 220, in conjunction with the rotation of the drum, the dried sand flows through the sand outflow 232 out of the drum dryer for further processing.

In summary, it can be stated that the described regeneration plant 200 for materials/material mixtures, such as, for example, inorganically bound foundry sands, and the method which can be carried out with it have optionally one or more of the following structural parts or features:
A washing drum 250 in which a material mixture can be mixed with a washing liquid, preferably with water.
A drum dryer 210, the inlet of which is connected to the outlet of the washing drum 250 and in which residues of the washing liquid can be evaporated.
The mixing of a material mixture with a washing liquid, such as, for example, water, mixing preferably taking place in a washing drum 250.
The discharge of washing liquid, together with constituents of a material mixture which are dissolved therein.
The evaporation of residues of the washing liquid, evaporation preferably taking place in a drum dryer 210.
The rotation of the washing drum 250 jointly with the drum dryer 210.
The condensation of the evaporated washing liquid in thermal contact with the material out of which washing liquid is evaporated.
The increase in the pressure of the evaporated washing liquid before or during its condensation.

FIG. 6 shows a sectional view of a washing dryer 300, that is to say a washing machine with an integrated dryer, which constitutes a structural modification of the drying machine 110 from FIGS. 1-3. The components similar to the drying machine mentioned are no longer explained in detail below.

In the washing dryer 300, the drying container (inner drum 320) serves at the same time as a washing chamber 350 in which, for example, textiles can be washed.

In the modification of the drying machine 110 of FIGS. 1-3, there is a multiplicity of radially running connections (holes 345) which connect the interior 321 of the drying container 320 through the condensation chamber to a (here stationary, alternatively rotatable) outside space.

In the embodiment illustrated, in this regard, the inner drum 320 for the washing operation is provided (as in a conventional washing machine) with holes 345 which are connected to the outer static container 344. The condensation chamber 330 is mounted, for example, between the holes 345 of the inner drum in the form of pockets or ducts 331 on the drum casing of the inner drum and/or on the end face (not illustrated) of the inner drum.

Washing water can be added from an outer stationary container 344, in which the inner drum 320 is mounted rotatably, or, in the inner space 346 of said container, the water can be discharged from the inner drum again during spinning.

After spinning and after the washing water has been pumped away, the inner drum 320 forms, together with the outside space 346 of the outer static housing 344, the pressure region for evaporation. Condensation takes place at higher pressure in the applied pockets/ducts 331.

One advantage of this embodiment is that there is no rotary connector required for connecting the inner region of the drying container 320 to the compressor 342, since the extraction of evaporated washing water can take place at the static outer container 344.

The production of the inner drum 320 may, for example, take place in that the outer rotating drum 330 and the inner drum 320 are laid one over the other as unrolled flat metal sheets and are connected at regular intervals by the spot welding method. The holes 345 can then be drilled through the spot welds. In a second step, the sheets can be rolled into a drum and a longitudinal seam can be welded. In the third step, the interspace between the outer and the inner sheet can be pumped up (hydroforming), as a result of which the condensation space 331 is formed.

Special exemplary embodiments of a method and a drying machine for the drying of materials, for example of foundry sands, laundry, cellulose materials and/or bulk materials, have been described with the aid of FIGS. 1-6. In this case, the materials to be dried are fed into a drying container in which liquid is evaporated. The steam occurring is conducted into a condensation chamber and in thermal contact with the material is condensed out of the drying container there. The condensation heat can thereby be recovered for a renewed evaporation process. The drying machine can be used particularly in a regeneration plant for inorganically bound foundry sands.

It is pointed out that all the technical features described in the application possess independent inventive significance, even if in the present case they have been explained in conjunction with other features.

1. A drying machine for the drying of materials, for example of foundry sands, laundry, cellulose materials and/or bulk materials, containing:
a drying container for receiving the materials; and
a condensation chamber which is connected to the drying container and in which steam can be condensed out of the drying container in thermal contact with the material of the drying container, the drying container containing a rotatably mounted drum dryer, and the condensation chamber being connected firmly to the drum dryer.

2. A method for the drying of materials, for example of foundry sands, laundry, cellulose materials and/or bulk materials, in a drying machine as claimed in claim 1, containing the steps:
evaporation of liquid out of the materials in the drying container; and
condensation of the evaporated liquid in the condensation chamber in thermal contact with the material out of which the liquid has been evaporated.

3. The drying machine, as claimed in claim 1, wherein the drying container is separated structurally from the condensation chamber, preferably by means of a common wall.

4. The drying machine, as claimed in claim 1, wherein the condensation chamber surrounds the drying container, or vice versa.

5. The drying machine, as claimed claim 1, wherein a compressor for increasing the pressure in the condensation chamber and/or for reducing the pressure in the drying container is present.

6. The drying machine for materials, such as, for example, foundry sands, laundry, cellulose materials and/or bulk materials, containing:
a washing chamber in which the materials can be mixed with a washing liquid; and
the drying machine as claimed in claim 1, in which residues of the washing liquid can be evaporated out of the washing chamber from materials.

7. The drying machine, as claimed in claim 1, wherein the materials are fed in batches or continuously.

8. The method for the drying of materials, as claimed in claim 2, wherein the drying container is separated structurally from the condensation chamber, preferably by means of a common wall.

9. The method for the drying of materials, as claimed in claim 2, wherein the condensation chamber surrounds the drying container, or vice versa.

10. The method for the drying of materials, as claimed in claim 2, wherein a compressor for increasing the pressure in the condensation chamber and/or for reducing the pressure in the drying container is present.

11. The method for the drying of materials, as claimed in claim 2, wherein the materials are fed in batches or continuously.
